(19) United States
(12) Patent Application Publication
(10) Pub. No.: US 2026/0001728 A1
(43) Pub. Date: Jan. 1, 2026

(54) WORKPIECE REMOVAL DEVICE, WORKPIECE REMOVAL METHOD, AND CONTROL DEVICE

(71) Applicant: Fanuc Corporation, Minamitsuru-gun, Yamanashi (JP)

(72) Inventor: Toshiyuki ANDO, Minamitsuru-gun, Yamanashi (JP)

(73) Assignee: Fanuc Corporation, Minamitsuru-gun, Yamanashi (JP)

(21) Appl. No.: 18/880,665

(22) PCT Filed: Jul. 26, 2022
(86) PCT No.: PCT/JP2022/028805

§ 371 Date: Jan. 2, 2025

(51) Int. Cl. B65G 47/90

(52) U.S. Cl. CPC B65G 47/905

(57) ABSTRACT

Provided are a workpiece removal device, a removal method, and a control device for efficiently removing workpieces in a container. The workpiece removal device is provided with: a robot equipped with a hand for removing a workpiece in a container; a shape setting unit for setting the shape of each of the hand, the container, and the workpiece; a sensor configured so as to detect the container and the workpiece in the container; a removal position/attitude determination unit for determining a removal position and a removal attitude for the hand for when the detected workpiece is removed with the hand; a relay position determination unit for determining a relay position at which the hand is above and inside the container and at which the attitude of the hand becomes the removal attitude when the operation of removing the detected workpiece is performed; and an operation control unit for causing the hand to move only by translational movement from the relay position to the removal position.

### CROSS REFERENCE TO RELATED APPLICATIONS

This is the U.S. National Phase application of PCT/JP2022/028805, filed Jul. 26, 2022, the disclosure of this application being incorporated herein by reference in its entirety for all purposes.

### FIELD OF THE INVENTION

Embodiments of the present invention relate to a workpiece picking device, a workpiece picking method and a controller.

### BACKGROUND OF THE INVENTION

In the prior art, a device configured to identify the positions and postures of randomly piled workpieces, and picking an identified workpiece by using a robot is well known. As such a device, a device is well known in which randomly piled workpieces are captured by a camera to obtain a two-dimensional image, or the workpieces are measured by a three-dimensional measuring instrument to obtain a set of three-dimensional points, and the position of the article is identified by pattern matching using of the two-dimensional image or the set of three-dimensional points (e.g., see Patent Literature 1 and 2).

Also, an article picking device is well known, configured to identify the positions and postures of randomly piled workpieces by using various three-dimensional measurement instruments, without executing pattern matching, and pick up the identified workpieces (e.g., see Patent Literature 3).

### Patent Literature

[PTL 1] JP 2004-295223 A

[PTL 2] JP 2011-179909 A

[PTL 3] JP 2015-089590 A

### SUMMARY OF THE INVENTION

A plurality of workpieces randomly piled in a container present various postures. In order to pick up the workpiece with various postures by using a robot, it is necessary to incline a hand attached to the robot corresponding to the posture of the workpiece. However, when the posture of the hand is changed corresponding to the posture of the workpiece immediately before picking the workpiece, the hand may interfere with the container and/or the other workpieces around the workpiece to be picked.

There are various methods to detect obstacles which may interfere with a robot using a 3D vision sensor. However, the vision sensor can only obtain superficial information regarding an upper part of the container, and the 3D vision sensor may fail to obtain 3D data. Therefore, it is difficult to reliably predict and avoid interference using the vision sensors.

Further, automatic path generation technology has been proposed to determine a movement trajectory of a robot so that the robot does not interfere with a surrounding environment. However, in order to realize such technology, a high-performance processing unit and considerable processing time are required.

One aspect of the present disclosure is a workpiece picking device comprising: a robot having a hand configured to pick up a workpiece in a container; a shape setting unit configured to set shapes of the hand, the container and the workpiece; a sensor configured to detect the container and the workpiece in the container; a picking position/posture determining unit configured to determine a picking position and a picking posture of the hand when the hand picks up a detected workpiece; a relay position determining unit configured to determine a relay position at which the hand is positioned above and inside the container and at which the posture of the hand presents the picking posture when the hand performs an operation for picking up the detected workpiece; and an operation control unit configured to move the hand from the relay position to the picking position only by translational movement.

Another aspect of the present disclosure is a workpiece picking method using a robot having a hand configured to pick up a workpiece in a container, the method comprising the steps of: setting shapes of the hand, the container and the workpiece; detecting the container and the workpiece in the container; determining a picking position and a picking posture of the hand when the hand picks up a detected workpiece; determining a relay position at which the hand is positioned above and inside the container and at which the posture of the hand presents the picking posture when the hand performs an operation for picking up the detected workpiece; and moving the hand from the relay position to the picking position only by translational movement.

Still another aspect of the present disclosure is a controller for a robot having a hand configured to pick up a workpiece in a container, and for a sensor configured to detect the container and the workpiece in the container, the controller comprising: a shape setting unit configured to set shapes of the hand, the container and the workpiece; a picking position/posture determining unit configured to determine a picking position and a picking posture of the hand when the hand picks up a detected workpiece; a relay position determining unit configured to determine a relay position at which the hand is positioned above and inside the container and at which the posture of the hand presents the picking posture when the hand performs an operation for picking up the detected workpiece; and an operation control unit configured to move the hand from the relay position to the picking position only by translational movement.

According to the present disclosure, the relay position is located above and inside the container, and the hand does not change its posture after reaching the relay position and approaches the object to be picked by translational movement only. Therefore, an efficient picking operation can be performed without the hand interfering with the container or the other workpieces.

### BRIEF DESCRIPTION OF DRAWINGS

FIG. 1 is a schematic configuration view of a workpiece picking device according to an embodiment.

FIG. 2 is a flowchart showing an example of a process when setting

FIG. 2 is a flowchart showing an example of a process when executing picking.

FIG. 4 is a schematic view of an example of a movement path of a hand.

### DETAILED DESCRIPTION OF EMBODIMENTS OF THE INVENTION

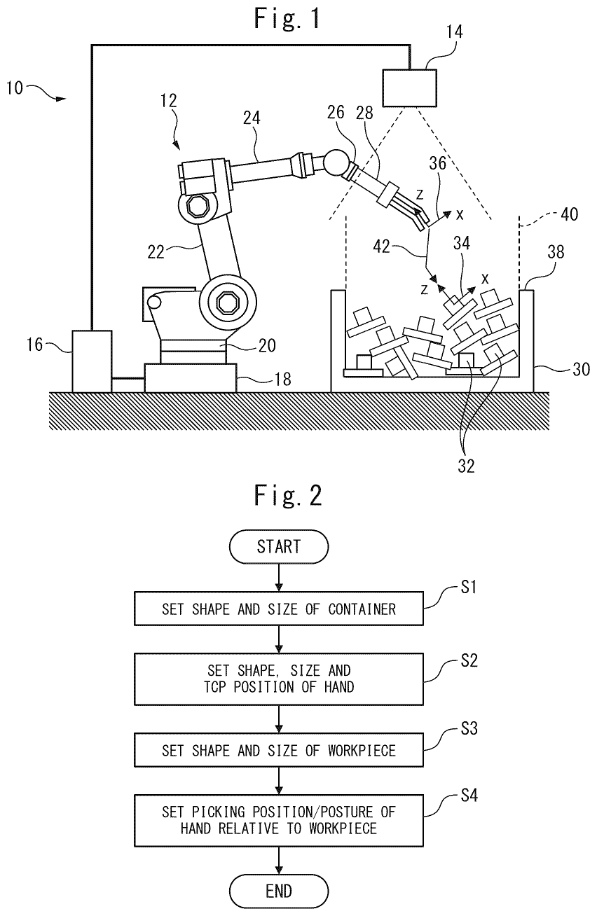

FIG. 1 is a schematic configuration view of a workpiece picking device according to a preferred embodiment. The workpiece picking device 10 includes at least one robot 12, a three-dimensional sensor 14, a controller 16 communicably connected to the robot 12 and the sensor 14 by wireless or wire and configured to control the robot 12 and the sensor 14.

The robot 12 is, for example, an industrial articulated robot having a serial link structure, and has a base 18 installed at a predetermined location such as a factory production line, a rotating body 20 rotatably attached to the base 18, a first arm (upper arm) 22 rotatably attached to the rotating body 20, a second arm (forearm) 24 rotatably attached to the first arm 22, a wrist part (mechanical interface) 26 rotatably attached to the second arm 24, and a robot hand 28 attached to the wrist part 26. The robot 12 is configured to pick up workpieces 32 one by one, which are randomly piled in a container 30.

In the embodiment, the three-dimensional sensor 14 is configured to detect the position of the container 30 and the workpiece 32 within the container 30, based on instructions from the controller 16. For example, a stereo camera configured to detect the three-dimensional position based on the parallax of images captured by two two-dimensional cameras, or a TOF (Time of Flight) camera configured to capture a distance image using an optical time-of-flight method, can be used.

The robot 12 is configured to be able to perform various operations such as picking up a workpiece based on a command transmitted from the controller 16. The controller 16 includes a processor and a storage unit (memory, etc.), and can control the robot 12 and the sensor 14 which detects the container 30 and the workpieces 32 within the container 30. In this embodiment, the processor of the robot controller 16 has functions of a shape setting unit for setting the shapes of the hand 28, the container 30 and the workpiece 32, a picking position/posture determining unit for determining the picking position and picking posture of the hand 28 when the hand 28 picks up the detected workpiece 32, a relay position determining unit for determining a relay position (described later) at which the hand 28 is positioned above and inside the container 30 and at which the posture of the hand 28 presents the picking posture when the hand 28 performs an operation for picking up the detected workpiece 32, and an operation control unit for moving the hand 28 from the relay position to the picking position by only translational movement. However, the present disclosure is not limited as such, for example, a computer (not shown) such as a personal computer (PC) connected to the controller 16 by wire or wirelessly and having a processor and a storage unit (memory, etc.) may generate a motion program of the robot, so that the generated program can be transmitted from the computer to the controller 16.

FIG. 2 is a flowchart showing an example of a process to be performed as a setting before actually picking up the workpieces 32 by the workpiece picking device 10. First, in step S1, the shape and size of the container 30, in which the workpieces 32 are randomly piled, are set. Next, in step S2, the shape and size of the robot hand 28, and the position of a representative point such as a tool center point (TCP) are set.

Next, in step S3, the shape and size of the workpiece 32 are set. Finally, in step S4, the picking position and the picking posture of the hand 28 relative to the workpiece 32, i.e., the position and posture of the hand 28 relative to the workpiece 32 when the hand 28 picks up the workpiece 32, are set. It should be noted that the settings in steps S1 to S4 may be performed by a user via an input unit (not shown) such as a suitable user interface, or may be automatically performed by the controller 16 or a processor of another computer, based on 3D models of the container, the hand, and the workpiece, etc.

FIG. 3 is a flowchart showing an example of a process when the workpiece 32 is picked up by the workpiece picking device 10. First, in step S11, 3D data of the container 30 and the workpiece 32 in the container 30 is acquired. Specifically, image data or a three-dimensional point cloud of the container 30 and the workpiece 32 obtained using the sensor 14.

Next, in step S12, the position of the container 30 is detected. Specifically, the position of the container 30 is determined based on a method such as model matching using the 3D data of the container 30 obtained in step S11 and the shape and size of the container 30 which are set in step S1 described above.

Next, in step S13, the position of the workpiece 32 in the container 30 is detected. Specifically, similarly to step S12, the position of the workpiece 32 is obtained based on a method such as model matching using the 3D data of the workpiece 32 obtained in step S11 and the shape and size of the workpiece 32 which are set in step S3 described above. At this time, the posture of the workpiece 32 can also be obtained.

Next, in step S14, the picking position and the picking posture of the hand 28 relative to the workpiece 32 are determined. Specifically, based on the position (or position and posture) of the workpiece 32 detected in step S13 and the picking position and the picking posture of the hand which are set in step S4 described above, the picking position and the picking posture of the hand 28 when picking up the detected workpiece 32 are determined.

Next, in step S15, a relay position through which the hand 28 must pass before reaching the pocking position determined in step S14 is determined. In this embodiment, the relay position is a position through which the hand 28 (or the representative point thereof, etc.) must pass before reaching the workpiece 32 to be picked, and at the relay position, the hand 28 is positioned above and inside the container 30 while presenting the picking posture as described above. Here, “above . . . the container” refers to a space vertically above an upper end 38 of the container 30 as shown in FIG. 1, and “inside the container” refers to a space obtained by sweeping an opening of the container 30 vertically upward, as shown by reference numeral 40 in FIG. 1.

A specific method for calculating the relay position may be, for example, to use CAD data of the hand 28 to determine whether or not there is interference between the hand 28 and the container 30 or the workpiece 32. However, since a robot hand generally has a complex shape, calculations using CAD data are accurate, while calculation processing may take a long time.

Therefore, for example, the shape of the hand 28 may be approximated to a basic shape including at least one of a sphere, a cylinder, a polygonal prism and a polyhedron which contains the shape of the hand 28, and the relay position may be determined so that an entire of the basic shape is positioned above and inside the container 30. Alternatively, a convex hull (convex polyhedron) encompassing the hand 28 may be determined from CAD data of the hand 28, and the relay position may be determined so that each vertex of the convex hull is positioned above and inside the container 30. In either case, the calculation time can be significantly reduced compared to using CAD data as is.

In addition, in step S15, there may be cases where the relay position which satisfies the above-mentioned condition (the relay position is above and inside the container) cannot be calculated or determined for the workpiece to be removed. In this case, it can be judged that there was a problem with which workpiece should be picked, so it is preferable not to pick the workpiece which has been determined to be picked, and to redo the operation by picking a different workpiece.

Next, in step S16, the hand 28 is moved to the relay position determined in step S15. Here, the robot 12 is controlled so that the hand 28 presents the picking posture determined in step S14 by the time it reaches the relay position. For example, as shown in FIG. 1, when the approach direction of the hand 28 relative to the workpiece 32 to be picked is the z-direction of a coordinate system 34 which is set for the workpiece 32, the hand 28 presents the picking posture at the relay position such that the z-direction of a coordinate system 36 which is set for the hand 28 is parallel to the z-direction of the coordinate system 34.

Next, in step S17, the hand 28 is translated (translationally moved) from the relay position to the workpiece picking position. For example, as shown in FIG. 1, the hand 28 moves from the relay position to the workpiece 32 to be picked along a movement path 42 without changing its posture. It should be noted that the movement path from the relay position to the workpiece to be picked may be a simple straight line, or may include straight lines in different directions connected by at least one bending point as shown in FIG. 1, or may include at least a partial curve.

Finally, in step S18, the workpiece 32 to be picked is picked up by gripping or suction, etc., with the hand 28. When picking another workpiece, the above-mentioned steps S11 to S18 are repeated.

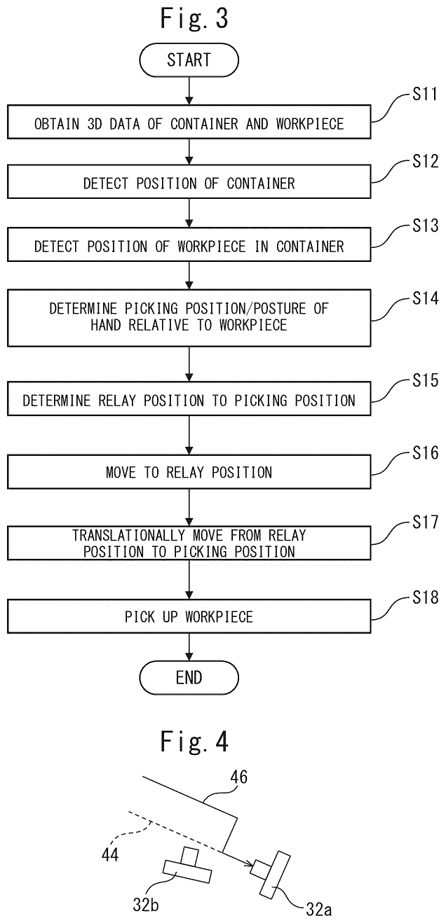

FIG. 4 is a schematic view for explaining an example of a process for determining the relay position. In case that a workpiece 32a is detected as a target to be picked, when the relay position is determined so that the hand 28 moves from the relay position to the workpiece 32a along a single straight line (movement path) 44, another workpiece 32b may interfere with the hand 28. On the other hand, in order to pick up the workpiece 32a, the hand 28 needs to move along the straight line 44 at least in the immediate vicinity of the workpiece 32a.

Therefore, as shown by reference numeral 46, by determining the relay position so that the hand 28 moves along a moving path away from the workpiece 32a to be picked by a certain distance and having a portion which is displaced upward, it is possible to pick up the workpiece 32a to be picked while reliably avoiding interference with the other workpieces 32b.

According to the embodiment described above, the relay position is above and inside the container 30, and the hand 28 does not change the posture thereof after the relay position and approaches the target to be picked only by translational movement. Therefore, the hand 28 does not interfere with the container 30 or the other workpieces 32, and can perform the picking operation smoothly.

### REFERENCE SIGNS LIST

10 workpiece picking device
12 robot
14 sensor
16 robot controller
28 robot hand
30 container
32, 32a, 32b workpiece
42, 44, 46 movement path

1. A workpiece picking device comprising:
a robot having a hand configured to pick up a workpiece in a container;
a shape setting unit configured to set shapes of the hand, the container and the workpiece;
a sensor configured to detect the container and the workpiece in the container;
a picking position/posture determining unit configured to determine a picking position and a picking posture of the hand when the hand picks up a detected workpiece;
a relay position determining unit configured to determine a relay position at which the hand is positioned above and inside the container and at which the posture of the hand presents the picking posture when the hand performs an operation for picking up the detected workpiece; and
an operation control unit configured to move the hand from the relay position to the picking position only by translational movement.

2. The workpiece picking device according to claim 1, wherein the relay position determining unit is configured to approximate the shape of the hand to a basic shape including at least one of a sphere, a cylinder, a polygonal prism and a polyhedron, and determine the relay position so that an entire of the basic shape is positioned above and inside the container.

3. The workpiece picking device according to claim 1, wherein the relay position determining unit is configured to determine a convex hull encompassing the hand, and determine the relay position so that each vertex of the convex hull is positioned above and inside the container.

4. The workpiece picking device according to claim 1, wherein operation control unit is configured to control the robot not to perform the operation of picking the detected workpiece when the relay position cannot be set above and inside the container.

5. The workpiece picking device according to claim 1, wherein the relay position determining unit is configured to determine the relay position so that the hand is moved along a movement path away from the detected workpiece by a certain distance, the movement path having a portion which is displaced upward.

6. A workpiece picking method using a robot having a hand configured to pick up a workpiece in a container, the method comprising the steps of:
setting shapes of the hand, the container and the workpiece;
detecting the container and the workpiece in the container;
determining a picking position and a picking posture of the hand when the hand picks up a detected workpiece;
determining a relay position at which the hand is positioned above and inside the container and at which the posture of the hand presents the picking posture when the hand performs an operation for picking up the detected workpiece; and
moving the hand from the relay position to the picking position only by translational movement.

7. A controller for a robot having a hand configured to pick up a workpiece in a container, and for a sensor configured to detect the container and the workpiece in the container, the controller comprising:
a shape setting unit configured to set shapes of the hand, the container and the workpiece;
a picking position/posture determining unit configured to determine a picking position and a picking posture of the hand when the hand picks up a detected workpiece;
a relay position determining unit configured to determine a relay position at which the hand is positioned above and inside the container and at which the posture of the hand presents the picking posture when the hand performs an operation for picking up the detected workpiece; and
an operation control unit configured to move the hand from the relay position to the picking position only by translational movement.
